(19) United States
(12) Patent Application Publication
(10) Pub. No.: US 2008/0279557 A1
(43) Pub. Date: Nov. 13, 2008

(54) WDM-PON SYSTEM USING SELF-INJECTION LOCKING, OPTICAL LINE TERMINAL THEREOF, AND DATA TRANSMISSION METHOD

(75) Inventors: Chang-Soo Park, Gwangju (KR); Tae-Young Kim, Gwangju (KR); Seung Hyeon Baek, Gwangju (KR); Seung Heon Han, Gwangju (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Gwangju Institute of Science and Technology, Gwangju (KR)

(21) Appl. No.: 12/112,153

(22) Filed: Apr. 30, 2008

(30) Foreign Application Priority Data
May 9, 2007 (KR) 10-2007-0044888

(51) Int. Cl. H04J 14/02

(52) U.S. Cl. 398/79; 398/169

(57) ABSTRACT

Disclosed are a wavelength division multiplexing-passive optical network (WDM-PON) system using self-injection locking, an optical line terminal thereof, and a data transmission method. A wavelength division multiplexing-passive optical network (WDM-PON) system according to an aspect of the invention includes an optical line terminal. The optical line terminal includes a reflector that is installed at the input side of a multiplexer and reflects an optical signal having a predetermined wavelength, and a light source that generates a multimode optical signal to transmit the generated multimode optical signal to the multiplexer through the reflector, receives reflected light by the reflector, and oscillates at a wavelength of the received reflected light. According to the aspect of the invention, it is not necessary to separately control the temperature of a light source for a downstream signal, and stable communication can be performed by collectively controlling wavelengths of downstream channel optical signals for downstream channels through temperature control of the multiplexer.

### BACKGROUND OF THE INVENTION

1. Technical Field

The present invention relates to a wavelength division multiplexing-passive optical network (WDM-PON) system, an optical line terminal thereof, and a data transmission method. More particularly, the present invention relates to a high-speed and large-capacity WDM-PON system that uses a reflector, such as Bragg grating, which reflects a signal having a specific wavelength, and a light source self-injection-locked by reflected light.

2. Related Art

A wavelength-division multiplexing (WDM) system means a communication system that uses lasers having different wavelengths to transmit different signals and multiplexes optical carrier signals in a single optical fiber. This system increases a capacity of communication data and enables bidirectional communication through one optical fiber line.

A wavelength division multiplexing-passive optical network (WDM-PON) means a network that discriminates wavelengths of optical signals used to transmit upstream data according to optical network units (ONU) and wavelengths of optical signals used to transmit downstream data according to optical line terminals, and groups a plurality of optical network units and provides access. The WDM-PON system uses an optical signal distributor (demultiplexer) to distribute a coupled optical signal of a multiwavelength to each physical link, and uses a WDM multiplexer to multiplex upstream/downstream channels.

The WDM-PON system according to the related art includes an optical transmitting terminal, a multiplexer (MUX), an optical fiber, a demultiplexer (DEMUX), and an optical receiving terminal. The optical transmitting terminal includes optical transmitters that oscillate signals of a plurality of channels (for example, 16 channels), respectively. The multiplexer multiplexes each channel signal of the optical transmitting terminal, the optical fiber transmits an optical signal, and the demultiplexer separates a multiplexed signal into signals for individual channels. The optical receiving terminal includes a plurality of optical receivers that detect channel signals, respectively. In the WDM-PON system, at the optical transmitting terminal in the optical line terminal (OLT), a downstream channel signal for a multichannel optical network unit oscillates at a passage wavelength of an optical network unit (ONU) that is located at a remote place, and the oscillated signal is multiplexed by a demultiplexer.

In a general passive optical network, an optical line terminal and a remote node are connected to each other by one optical fiber, and the remote node and an optical network unit are connected to each other by an independent optical fiber. At this time, a multiplexer and a demultiplexer should be installed in the optical line terminal and the remote node to combine a plurality of wavelengths and separate a multiwavelength. As the multiplexer/demultiplexer for combining wavelengths or separating a multiwavelength, an arrayed waveguide grating (AWG) is mainly used.

However, since the remote node and the optical network unit are not provided with an apparatus to maintain the remote node and the optical network unit at the same temperature, a temperature difference is generated between the remote node and the optical network unit. The arrayed waveguide grating that is used as the multiplexer/demultiplexer differently separates a wavelength in response to the change in temperature. When the multiplexer/demultiplexer is formed of a silica material, a change rate of a wavelength according to the change in temperature is about 0.01 nm/° C.

In the WDM-PON system, when the temperature of the remote node changes with time, wavelength separation of the arrayed waveguide grating changes. As a result, the wavelength of a light source for data transmission is not matched with the wavelength of the arrayed waveguide grating located at the remote node. Due to this, output loss occurs and noise occurs between adjacent channels, thereby lowering signal transmission performance. In particular, a self-injection locking light source, such as a Fabry-Perot laser, is a low-priced light source for wavelength separation, and has a large change in wavelength due to a change in temperature. Therefore, it is required to install a separate apparatus that allows the optical line terminal (OLT) to detect a temperature change in the remote node (RN) through remote control.

Korean Patent Laid-Open Publication No. 2001-19017 discloses a wavelength tracking method that extracts a portion of a multiplexed upstream signal to generate a reference voltage, extracts a portion of a demultiplexed upstream channel signal output from a demultiplexer to generate a monitoring voltage, and increases or decreases the temperature of the demultiplexer according to the difference between the reference voltage and the monitoring voltage. According to the technology that is disclosed in Korean Patent Laid-Open Publication No. 2001-19017, since it is not possible to perform temperature monitoring on all optical network units, it is required to install a separate apparatus that individually controls the temperature according to each optical network unit. Therefore, this technology is complex and inefficient when implementing a system.

### SUMMARY OF THE INVENTION

The invention has been finalized in consideration of a problem according to the related art in that a temperature of a light source needs to be individually controlled for each optical network unit. It is an object of the invention to provide a wavelength division multiplexing-passive optical network system using self-injection locking that includes a reflector, which is installed at the input side of a multiplexer and reflects an optical signal having a specific wavelength, and an optical line terminal having a new structure oscillating at a wavelength of reflected light by the reflector in a self-injection locking state.

According to an aspect of the invention, a wavelength division multiplexing-passive optical network (WDM-PON) system includes an optical line terminal that includes a multiplexer, a reflector, and a light source, the multiplexer multiplexing an optical signal and transmitting the optical signal downward, the reflector located at the input side of the multiplexer and reflecting an optical signal having a predetermined wavelength, the light source generating a multimode optical signal to transmit the multimode optical signal to the multiplexer through the reflector, receiving an optical signal reflected by the reflector, and oscillating at a wavelength of the received optical signal; and a remote node that includes a demultiplexer that demultiplexes the multiplexed optical signal and generates a single mode optical signal.

According to another aspect of the invention, there is provided an optical line terminal that is used in a wavelength division multiplexing-passive optical network (WDM-PON) system. The optical line terminal includes a multiplexer that multiplexes an optical signal and transmits the optical signal downward; a reflector that is located at the input side of the multiplexer and reflects an optical signal having a predetermined wavelength; and a light source that generates a multimode optical signal to transmit the multimode optical signal to the multiplexer through the reflector, receives the optical signal reflected by the reflector, and oscillates at a wavelength of the received optical signal.

According to still another aspect of the invention, there is provided a method of transmitting downstream data on a wavelength division multiplexing communication network. The method includes generating a multimode optical signal in a light source that oscillates at a wavelength of an input optical signal; transmitting the generated optical signal to a multiplexer that includes a reflector reflecting an optical signal having a specific wavelength; allowing reflected light by the reflector to be input to the light source; and allowing the light source to oscillate at a wavelength of the input reflected light and transmit downstream data.

### BRIEF DESCRIPTION OF THE DRAWINGS

FIG. 1 is a block diagram illustrating a WDM-PON system using self-injection locking according to an embodiment of the invention;

FIG. 2 is a block diagram illustrating a WDM-PON system using self-injection locking according to another embodiment of the invention;

FIG. 3 is a block diagram illustrating a WDM-PON system with bidirectional symmetry using self-injection locking according to still another embodiment of the invention; and

FIG. 4 is a flowchart illustrating a downstream data transmission method of a wavelength division multiplexing communication network according to an embodiment of the invention.

### DESCRIPTION OF EXEMPLARY EMBODIMENT

Hereinafter, a WDM-PON system using self-injection locking, an optical line terminal thereof, and a data transmission method according to embodiments of the invention will be described in detail with reference to the accompanying drawings.

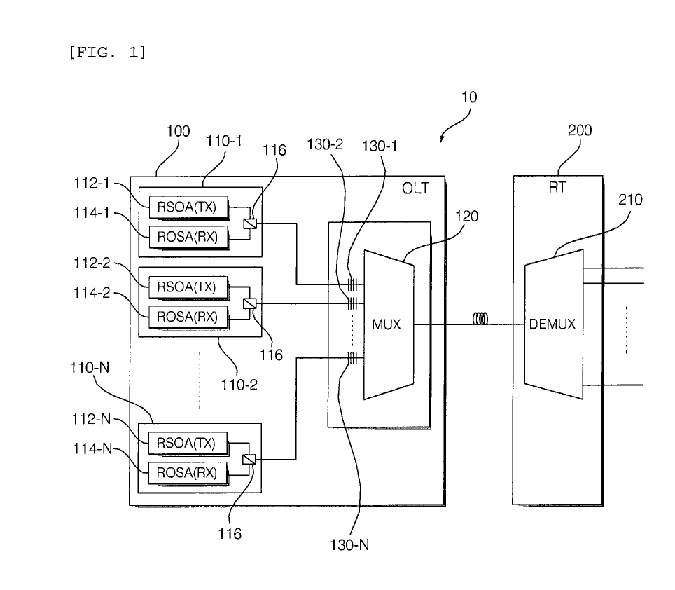

FIG. 1 is a block diagram illustrating a WDM-PON system 10 using self-injection locking according to an embodiment of the invention.

A WDM-PON system 10 according to this embodiment includes an optical line terminal (OLT) 100 and a remote node (RN) 200. The optical line terminal 100 includes an optical transceiver 110, a multiplexer 120, and a reflector 130, and the remote node 200 includes a demultiplexer 210. The optical line terminal 100 and the remote node 200 are connected to each other by a feeder fiber. In particular, the WDM-PON system 10 according to this embodiment has a reflector installed at an input side of a multiplexer, different from the structure of the related art.

The optical line terminal 100 provides a downstream channel optical signal to the demultiplexer 210 in the remote node 200, and receives an upstream channel optical signal from the demultiplexer 210. The optical transceiver 110 as a light source for optical communication generates a multimode optical signal, and receives a single mode optical signal from an optical network unit.

The optical line terminal 100 includes N optical transceivers 110-1, 110-2, . . . , and 110-N according to the number N of optical network units. The N optical transceivers 110-1, 110-2, . . . , and 110-N include N RSOA 112-1, 112-2, . . . , and 112-N, and N ROSA 114-1, 114-2, . . . , and 114-N, respectively.

In this embodiment, a reflective semiconductor optical amplifier (RSOA) is used as a light-amplifying light source that receives a threshold current or more or light and generates a broadband optical signal. The RSOA 112 receives reflected light that is reflected by the reflector 130, oscillates at a wavelength of the received reflected light, and generates a downstream channel optical signal.

In this embodiment, the broadband optical signal that has oscillated by the RSOA 112 is input to the multiplexer 120 through a single mode optical fiber. In this embodiment, N different reflectors 130-1, 130-2, . . . , and 130-N that reflect optical signals having specific wavelengths are provided at the input side of the multiplexer 120. Among the optical signals that are generated by the RSOA 112 and then input to the multiplexer 120, the optical signals having the specific wavelengths are reflected on the reflector 130 and then input to the RSOA 112. The RSOA 112 enters a self-injection locking state where the RSOA 112 oscillates at an input wavelength band. The RSOA 112 in the self-injection locking state generates an optical signal having a spectrum that is similar to that of a single wavelength laser diode, modulates the generated optical signal, and transmits the modulated optical signal to the multiplexer 120 in a single mode.

In this embodiment, the RSOA that can perform modulation itself is used as a light source, but the invention is not limited thereto. In addition to the RSOA, a Fabry-Perot laser diode (FP-LD) and a vertical cavity surface emitting laser (VCSEL) may be used as the light source.

Meanwhile, a WDM filter 116 is a filter that discriminates optical signals on the basis of wavelengths. The WDM filter 116 discriminates an optical signal that is transmitted by the RSOA 112 and an optical signal that is received by an ROSA (receiver optical subassembly) 114 and passes the optical signals.

The multiplexer (MUX) 120 multiplexes the optical signal that is generated by the RSOA 112 and transmits downward. For example, an NX1 arrayed waveguide grating (AWG) or a waveguide grating router (WGR) may be used as the multiplexer. The multiplexer, such as the arrayed waveguide grating, may also be used as a demultiplexer, but is called the multiplexer in consideration of downstream data transmission in this embodiment.

In this embodiment, at the input side, the multiplexer 120 is connected to or integrated with the reflector 130 that reflects only an optical signal having a specific wavelength.

It is preferable that the reflector 130 be a Bragg grating (BG). The Bragg grating makes only an optical signal having a specific wavelength among multimode optical signals input from the RSOA 112 be subjected to retroreflection, and the optical signal that has been subjected to retroreflection is input to the light source again.

In particular, it is preferable that bases of the Bragg grating and the multiplexer be formed of the same material or materials having similar temperature characteristics. For example, the Bragg grating and the multiplexer may be formed of a silica material. If the Bragg grating and the multiplexer are formed using the same material, the change in temperature of the Bragg grating and the multiplexer may be equally maintained. In this case, if the Bragg grating and the multiplexer have the similar temperature characteristics, this means that the difference between the Bragg grating and the multiplexer in heat conduction characteristic or specific heat is within a predetermined value.

The remote node 200 receives optical signals from the optical line terminal 100 and the optical network unit, respectively, and transmits the optical signals to the sites opposite to the signal reception sites, respectively. The remote node 200 includes a demultiplexer 210 that demultiplexes the multiplexed optical signal.

The demultiplexer (DEMUX) 210 demultiplexes the multiplexed optical signal. Kinds of the demultiplexer 210 are not limited. Examples of the demultiplexer include a 1XN arrayed waveguide grating and a waveguide grating router (WGR). In particular, in a waveguide grating, a thermo-electric cooler (TEC) may mount a waveguide grating router in order to cause a temperature change of a router. In this case, the TEC may be set such that the temperature of the waveguide grating router serving as a wavelength distributor may be periodically changed. The TEC may be used as the demultiplexer in this embodiment.

When the temperature of the demultiplexer 210 changes, a center wavelength of an optical signal that is allocated to each channel moves, which increases optical transmission error and optical loss at the time of optical communication. Accordingly, the optical line terminal 110 needs to monitor the change in temperature of the remote node 200 and generate an optical signal corrected in response to the change in temperature. In this embodiment, the reflector 130 transmits information, which indicates the temperature change in the multiplexer 120 and a result of movement of a center wavelength due to the temperature change, to the side of the RSOA 112. Since the optical signal reflected by the reflector is an optical signal whose center wavelength has moved due to the change in temperature of the multiplexer 120, the RSOA 112 oscillates in consideration of the temperature change of the reflector 120, and thus it is not necessary to separately perform temperature control in the RSOA. That is, according to this embodiment, channel wavelength information for each downstream channel is collectively controlled through temperature control for the multiplexer 120 of the optical line terminal 100, and it is possible to perform stable communication. This embodiment is advantageous in that it is not required to individually control the temperature of a laser light source.

The WDM-PON system according to this embodiment preferably further includes a temperature synchronizing unit (not shown) that controls the temperature of the multiplexer 120. The temperature synchronizing unit maintains the temperature of the remote node 200, particularly, the temperature of the demultiplexer 210, and the temperature of the multiplexer 120 at the same temperature. The temperature synchronizing unit receives temperature information for the demultiplexer 210, and controls the temperature of the multiplexer 120 using a heating/cooling device. If the temperatures of the multiplexer 120 and the demultiplexer 210 are synchronized with each other by the temperature synchronizing unit and a center wavelength at which the RSOA oscillates is controlled by the reflector located at the input side of the multiplexer, it is possible to further improve optical transmission error and optical loss at the time of optical communication.

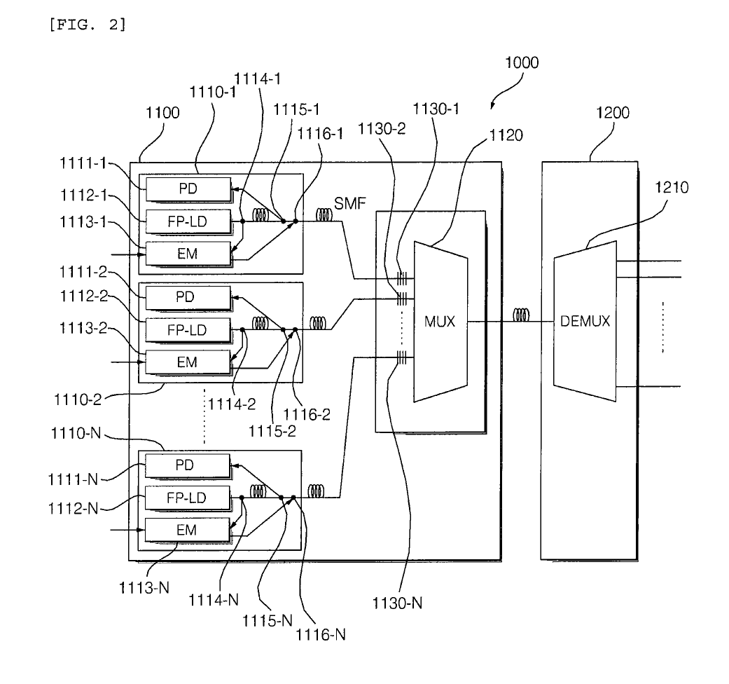

FIG. 2 is a block diagram illustrating a WDM-PON system 1000 using self-injection locking according to another embodiment of the invention.

The WDM-PON system 1000 shown in FIG. 2 includes an optical line terminal 1100 and a remote node 1200. The optical line terminal 1100 includes an optical transceiver 1110, a multiplexer 1120, and a reflector 1130, and the remote node 1200 includes a demultiplexer 1210.

The optical line terminal 1100 provides a downstream channel optical signal to the demultiplexer 1210 in the remote node 1200, and receives an upstream channel optical signal generated at the optical network unit side from the demultiplexer 1210. The optical line terminal 1100 includes N optical transceivers 1110-1, 1110-2, . . . , and 1110-N according to the number N of optical network units. The N optical transceivers 1110-1, 1110-2, . . . , and 1110-N include photodiodes 1111-1, 1111-2, . . . , and 1111-N, Fabry-Perot laser diodes 1112-1, 1112-2, . . . , and 1112-N, and modulators 1113-1, 1113-2, . . . , and 1113-N, respectively.

Different from the optical transceiver shown in FIG. 1, the optical transceiver 1110 shown in FIG. 2 includes a Fabry-Perot laser diode (FP-LD) 1112 as a light source. The Fabry-Perot laser diode 1112 receives an optical signal of a wavelength that is reflected by the Bragg grating 1130 located at the input side of the multiplexer 1120 and oscillates at the input wavelength. The optical signal that has oscillated at the specific wavelength by the reflected light is input to the modulator 1113 through an optical power splitter 1114. The optical power splitter 1114 splits the optical power self-injection-locked by inputting the reflected light. The modulator 1113 carries a control signal input to the modulator 1113 in a single mode optical signal input from the Fabry-Perot laser diode 1112 and modulates the corresponding signal. The modulator 1113 transmits the modulated optical signal to the multiplexer through a single mode optical fiber (SMF).

The photodiode 1111 receives an upstream channel optical signal through a wavelength selective coupler (WSC) 1115. The wavelength selective coupler 1115 splits optical signals on the basis of wavelengths. An optical coupler 1116 couples an optical signal transmitted from the Fabry-Perot laser diode 1112 and an optical signal transmitted from the modulator 1113. In order to improve efficiency of input light, a polarization controller may be located between the wavelength selective coupler 1115 and the optical power splitter 1114.

The multiplexer 1120 receives a downstream channel optical signal that is generated by the Fabry-Perot laser diode 1112 and the modulator 1113, multiplexes the downstream channel optical signal, and transmits the downstream channel optical signal downward. The multiplexer 1120 and the reflector 1130 are the same as the multiplexer 120 and the reflector 130 shown in FIG. 1, and thus the description thereof will be omitted.

The remote node 1200 receives the optical signals transmitted from the optical line terminal 1100 and the optical network unit and transmits the optical signals to the sides opposite to the signal reception sides. The remote node 1200 includes a demultiplexer 1210 that demultiplexes the multiplexed optical signal. The remote node 1200 and the demultiplexer 1210 shown in FIG. 2 are the same as the remote node 200 and the demultiplexer 210 shown in FIG. 1, and thus the description thereof will be omitted.

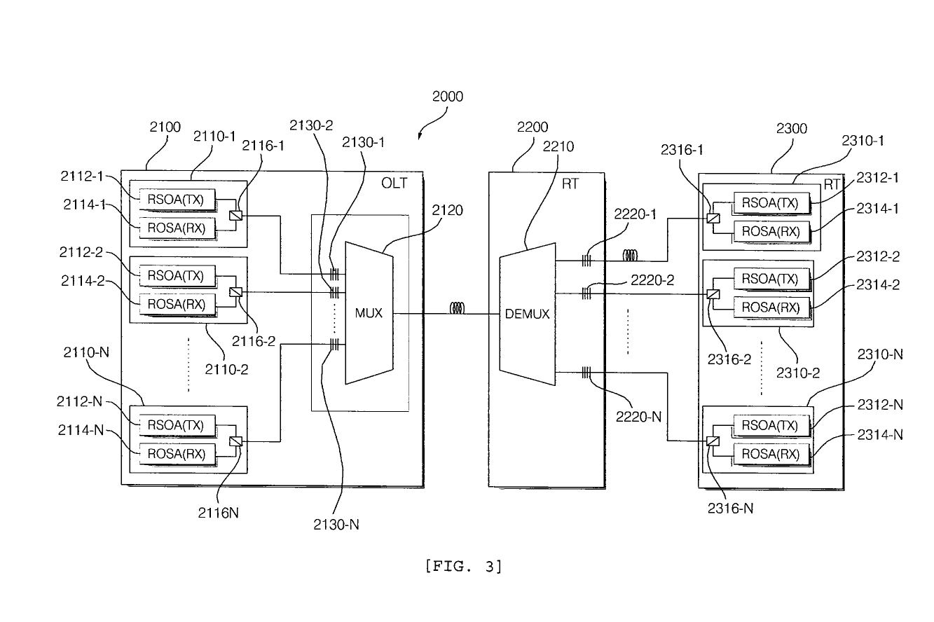

FIG. 3 is a block diagram illustrating a WDM-PON system 2000 with bidirectional symmetry using self-injection locking according to still another embodiment of the invention.

The WDM-PON system 2000 with bidirectional symmetry according to this embodiment includes an optical line terminal 2100, a remote node 2200, and an optical network unit 2300. The optical line terminal 2100 includes a first optical transceiver 2110, a multiplexer 2120, and a first reflector 2130. The remote node 2200 includes a demultiplexer 2210 and a second reflector 2220, and the optical network unit 2300 includes a second optical transceiver 2310.

The optical line terminal 2100 generates a downstream channel optical signal, and transmits the generated downstream channel optical signal to the optical network unit 2300 through the remote node 2200. In this embodiment, the optical line terminal 2100 includes an optical transceiver 2110, a multiplexer 2120, and a reflector 2130 that is located at the input side of the multiplexer. The optical transceiver 2110 includes N reflective semiconductor optical amplifiers (RSOA) 2112 and N receiver optical subassemblies (ROSA) 2114 according to the number N of optical network units 2114. In this embodiment, in order to discriminate the optical transceiver 2110 from the optical transceiver 2310 located at the side of the optical network unit 2300, the former is called a first optical transceiver. The optical line terminal 2100 shown in FIG. 3 and the optical line terminal 100 shown in FIG. 1 are the same, and thus the description thereof will be omitted in order to avoid the repetitive description.

The remote node 2200 transmits a downstream channel optical signal generated by the optical line terminal 2100 to the optical network unit 2300, and an upstream channel optical signal generated by the optical network unit 2300 to the optical line terminal 2100. The remote node 2200 includes a demultiplexer 2210 that demultiplexes the multiplexed optical signal and a reflector 2220 that is located at the output side of the demultiplexer 2210.

The reflector 2220 reflects an optical signal having a specific wavelength among multimode optical signals that are generated by the optical network unit 2300. The Bragg grating reflects an optical signal having a specific wavelength among multimode optical signals that are input from the RSOA 2312 of the optical network unit 2300. In this embodiment, it is preferable that the Bragg grating and the demultiplexer be formed of the same material or materials having similar temperature characteristics. Bases of the demultiplexer and the Bragg grating may be formed of a silica material, and in this case, the Bragg grating and the demultiplexer may be maintained at the same temperature.

The optical network unit 2300 provides an upstream channel optical signal to the demultiplexer 2210 in the remote node 2200, and receives a downstream channel optical signal from the demultiplexer 2210. The optical network unit 2300 includes N second optical transceivers 2310 according to the number N of optical network units, and each of the second optical transceivers 2310 includes an RSOA 2312, an ROSA 2314, and a WDM filter 2316. The RSOA 2312 at the optical network unit side generates a multimode optical signal in order to transmit upstream channel data. The multimode optical signal is input to the demultiplexer 2210 through the reflector 2220. At this time, the reflector 2220 reflects an optical signal having a specific wavelength among the input optical signals. The reflected light is input to the RSOA 2312 again, and the RSOA oscillates on the basis of the wavelength of the input optical signal.

The ROSA 2314 receives a downstream channel optical signal that is generated by the optical line terminal 2100. The WDM filter 2316 discriminates optical signals on the basis of wavelengths such that the optical signals are discriminated into upstream channel optical signals and downstream channel optical signals.

The WDM-PON system with bidirectional symmetry that is shown in FIG. 3 controls the temperature of the multiplexer of the optical line terminal according to the temperature change of the remote node. Since the self-injection-locked wavelength of the optical network unit is controlled, the WDM-PON system with bidirectional symmetry has a structure of a colorless light source that does not depend on the change in temperature of the remote node, and can minimize optical transmission error and optical loss at the time of optical communication. The WDM-PON system with bidirectional symmetry according to this embodiment has a vertically symmetric structure and can use the optical transceivers of the optical line terminal and the optical network unit as the same module, and thus is effective for mass production and reduction of system costs.

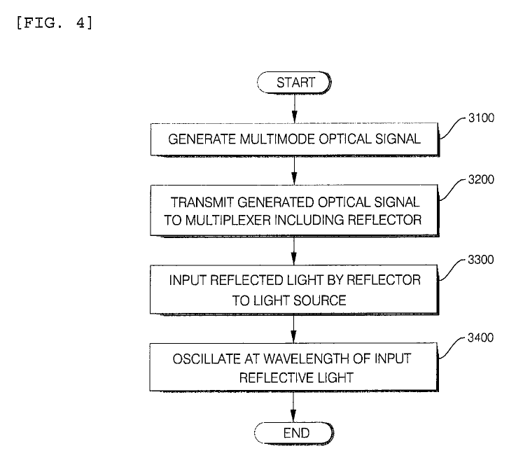

FIG. 4 is a flowchart illustrating a downstream data transmission method of a wavelength division multiplexing communication network according to an embodiment of the invention. A downstream data transmission method according to this embodiment includes steps, which are time-serially processed in the WDM-PON system 10 and will be described below.

In Step S3100, the RSOA 112 generates a multimode optical signal. The RSOA 112 is a self-injection-locked light source that oscillates at a wavelength of input light, and may use, as a light source, a Fabry-Perot laser diode as well as the RSOA.

In Step S3200, the RSOA 112 transmits the generated optical signal to the side of the multiplexer that includes a reflector that reflects an optical signal having a specific wavelength.

In Step S3300, the RSOA 112 receives reflected light that is reflected by the reflector. The reflector 130 reflects an optical signal having a specific wavelength among multimode optical signals that are generated by the RSOA 112.

In Step S3400, the RSOA 112 oscillates at a wavelength of the input reflected light and transmits downstream data. The RSOA 112 is self-injection-locked at a wavelength of the optical signal that is reflected by the reflector and then input to the RSOA 112, and oscillates on the basis of the wavelength. Although not shown in FIG. 4, the optical signal that is output from the light source oscillating in a self-injection locking state and the optical signal that is obtained by modulating the input control signal for optical modulation using the modulator (not shown) are transmitted to the multiplexer and the remote node.

According to the embodiments of the invention, the WDM-PON system includes a reflector that is installed at the input side of the multiplexer to reflect an optical signal having a specific wavelength and introduces an optical line terminal having a new structure that oscillates at a wavelength of the reflected light reflected by the reflector in a self-injection locking state. As a result, it is not necessary to separately control the temperature or wavelength of the light source for a downstream signal, and stable communication can be performed by collectively controlling wavelengths of downstream channel optical signals for downstream channels through temperature control of the multiplexer.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects. The scope of the present invention is defined by the appended claims rather than by the description preceding them, and all changes and modifications that fall within metes and bounds of the claims, or equivalents of such metes and bounds are therefore intended to be embraced by the claims.

What is claimed is:

1. A wavelength division multiplexing-passive optical network (WDM-PON) system comprising:
an optical line terminal that includes a multiplexer, a reflector, and a light source, the multiplexer multiplexing an optical signal and transmitting the optical signal downward, the reflector located at the input side of the multiplexer and reflecting an optical signal having a predetermined wavelength, the light source generating a multimode optical signal to transmit the multimode optical signal to the multiplexer through the reflector, receiving an optical signal reflected by the reflector, and oscillating at a wavelength of the received optical signal; and
a remote node that includes a demultiplexer that demultiplexes the multiplexed optical signal and generates a single mode optical signal.

2. The WDM-PON system of claim 1,
wherein the reflector is a Bragg grating, and
the Bragg grating is connected to the multiplexer or integrated with the multiplexer.

3. The WDM-PON system of claim 1,
wherein the multiplexer and the reflector are formed of the same material or different kinds of materials whose temperature characteristics are within a predetermined similarity range.

4. The WDM-PON system of claim 1,
wherein the light source is a Fabry-Perot laser diode (FP-LD), a reflective semiconductor optical amplifier (RSOA) or a vertical cavity surface emitting laser (VCSEL).

5. The WDM-PON system of claim 1, further comprising:
a reflector that is installed at the output side of the demultiplexer to reflect an optical signal having a predetermined wavelength, and
an optical network unit that generates a multimode optical signal, receives the optical signal reflected by the reflector, and oscillates at a wavelength of the received optical signal.

6. The WDM-PON system of claim 1, further comprising:
a temperature synchronizing unit that monitors the temperature of the demultiplexer and maintains the demultiplexer and the multiplexer at the same temperature.

7. An optical line terminal that is used in a wavelength division multiplexing-passive optical network (WDM-PON) system, the optical line terminal comprising:
a multiplexer that multiplexes an optical signal and transmits the optical signal downward;
a reflector that is located at the input side of the multiplexer and reflects an optical signal having a predetermined wavelength; and
a light source that generates a multimode optical signal to transmit the multimode optical signal to the multiplexer through the reflector, receives the optical signal reflected by the reflector, and oscillates at a wavelength of the received optical signal.

8. The optical line terminal of claim 7,
wherein the reflector is a Bragg grating, and
the Bragg grating is connected to the multiplexer or integrated with the multiplexer.

9. The optical line terminal of claim 7, further comprising:
a temperature synchronizing unit that monitors the temperature of a demultiplexer and maintains the demultiplexer and the multiplexer at the same temperature.

10. A method of transmitting downstream data on a wavelength division multiplexing communication network, the method comprising:
generating a multimode optical signal in a light source that oscillates at a wavelength of an input optical signal;
transmitting the generated optical signal to a multiplexer that includes a reflector reflecting an optical signal having a predetermined wavelength;
allowing reflected light by the reflector to be input to the light source; and
allowing the light source to oscillate at a wavelength of the input reflected light and transmit downstream data.

11. The method of claim 10,
wherein the reflector is a Bragg grating, and
the Bragg grating is connected to the multiplexer or integrated with the multiplexer.

12. The method of claim 10,
wherein the light source is a Fabry-Perot laser diode (FP-LD), a reflective semiconductor optical amplifier (RSOA) or a vertical cavity surface emitting laser (VCSEL).
